(19) United States
(12) Patent Application Publication
(10) Pub. No.: US 2014/0266031 A1
(43) Pub. Date: Sep. 18, 2014

(54) WIRELESS POWER SUPPLY SYSTEM, POWER TRANSMISSION CONTROLLING APPARATUS AND POWER RECEPTION CONTROLLING APPARATUS

(71) Applicant: KABUSHIKI KAISHA TOSHIBA, Minato-ku (JP)

(72) Inventor: Kenichi Sasaki, Kamakura-Shi (JP)

(73) Assignee: KABUSHIKI KAISHA TOSHIBA, Minato-ku (JP)

(21) Appl. No.: 14/021,646

(22) Filed: Sep. 9, 2013

(30) Foreign Application Priority Data
Mar. 13, 2013 (JP) 2013-050656

(51) Int. Cl. H01F 38/14; H02J 7/02

(52) U.S. Cl. CPC H01F 38/14; H02J 7/025
USPC 320/108; 307/104

(57) ABSTRACT

A wireless power supply system according to an embodiment includes a power transmitting unit that transmits electric power. The wireless power supply system includes a power receiving unit that receives the electric power output from the power transmitting unit. Even if one of a plurality of power transmitting coils stops transmitting electric power, the wireless power supply system can increase the electric power transmitted by the other power transmitting coils.

### CROSS-REFERENCE TO RELATED APPLICATION

This application is based upon and claims the benefit of priority from the prior Japanese Patent Application No. 2013-050656, filed on Mar. 13, 2013, the entire contents of which are incorporated herein by reference.

### BACKGROUND

1. Field

Embodiments described herein relate generally to a wireless power supply system.

2. Background Art

There is a wireless power supply system including a power transmitting unit and a power receiving unit.

### BRIEF DESCRIPTION OF THE DRAWINGS

FIG. 1 is a diagram showing an example of a configuration of a wireless power supply system 100 according to a first embodiment; and

FIG. 2 is a diagram showing an example of an arrangement of first and second power transmitting coils “LT1” and “LT2” of a power transmitting unit “TX” and first and second power receiving coils “LR1” and “LR2” of a power receiving unit “RX” of the wireless power supply system 100 shown in FIG. 1.

### DETAILED DESCRIPTION

A wireless power supply system according to an embodiment includes a power transmitting unit that transmits electric power. The wireless power supply system includes a power receiving unit that receives the electric power output from the power transmitting unit.

The power transmitting unit includes: a plurality of power transmitting coils; a plurality of drivers that are provided in a one-to-one relationship with the plurality of power transmitting coils and drive the power transmitting coils by supplying an alternating-current voltage to the power transmitting coils to flow a primary current through the power transmitting coils; a plurality of message decoders that are provided in a one-to-one relationship with the plurality of power transmitting coils, decode a received message and output information included in the message; and a controlling circuit that controls the plurality of drivers associated with the plurality of message decoders based on the information output from the plurality of message decoders, thereby controlling a frequency of the alternating-current voltage supplied to the plurality of power transmitting coils associated with the plurality of message decoders.

The power receiving unit includes: a plurality of power receiving coils capable of being electromagnetically coupled with the plurality of power transmitting coils; a plurality of rectifiers that are provided in a one-to-one relationship with the plurality of power receiving coils, rectify a secondary current flowing through the power receiving coils and output the rectified secondary current; a plurality of message transmitters that are provided in a one-to-one relationship with the plurality of power receiving coils and transmit a message including information based on an output voltage output from the plurality of rectifiers to the plurality of message decoders; and a charger that receives the output voltage output from the plurality of rectifiers and charges a battery.

a first message transmitter of the plurality of message transmitters associated with a first power receiving coil outputs a message including information on an output voltage output from a first rectifier.

a first message decoder of the plurality of message decoders associated with a first power transmitting coil decodes a received message and outputs information included in the message.

if the information output from the first message decoder shows that the output voltage output from the first rectifier is lower than a preset threshold, the controlling circuit stops a first driver driving the first power transmitting coil drives a second power transmitting coil of the plurality of power transmitting coils, which is different from the first power transmitting coil, by making a second driver of the plurality of drivers, which is different from the first driver, supply an alternating-current voltage to the second power transmitting coil to flow a primary current through the second power transmitting coil in such a manner that electric power transmitted from the second power transmitting coil to a second power receiving coil of the plurality of power receiving coils, which is different from the first power receiving coil, is amplified, and controls the plurality of drivers so that the electric power transmitted from the plurality of power transmitting coils to the plurality of power receiving coils before the first driver stops driving the first power transmitting coil is equal to the electric power transmitted from the plurality of power transmitting coils to the plurality of power receiving coils after the first driver stops driving the first power transmitting coil.

In the following, an embodiment will be described with reference to the drawings.

### First Embodiment

FIG. 1 is a diagram showing an example of a configuration of a wireless power supply system 100 according to a first embodiment. FIG. 2 is a diagram showing an example of an arrangement of first and second power transmitting coils “LT1” and “LT2” of a power transmitting unit “TX” and first and second power receiving coils “LR1” and “LR2” of a power receiving unit “RX” of the wireless power supply system 100 shown in FIG. 1. In FIG. 2, the other components than the power receiving coils and the power transmitting coils are omitted.

As an example, FIGS. 1 and 2 show two power transmitting coils and two power receiving coils. However, the wireless power supply system may include three or more power transmitting coils and three or more power receiving coils.

As shown in FIG. 1, the wireless power supply system 100 includes the power transmitting unit “TX” and the power receiving unit “RX”.

The power transmitting unit “TX” is configured to transmit electric power. For example, the power transmitting unit “TX” is a charger for a mobile device, such as a smart phone and a tablet PC.

The power receiving unit “RX” is configured to receive the electric power output from the power transmitting unit “TX”. For example, the power receiving unit “RX” is a battery, a mobile device incorporating a battery, such as a smart phone and a tablet PC, or a battery charging device to be connected to such a device. The power receiving unit “RX” may be any other device that receives electric power output from an associated power transmitting unit “TX”, such as a rechargeable electric car, a household electric appliance and a product for an underwater application.

Power transmission from the power transmitting unit “TX” to the power receiving unit “RX” is achieved by forming a power transmission transformer by electromagnetically coupling the power transmitting coils (primary coils) “LT1” and “LT2” provided in the power transmitting unit “TX” and the power receiving coils (secondary coils) “LR1” and “LR2” provided in the power receiving unit “RX” with each other. In this way, power transmission can be achieved in a non-contact manner.

As shown in FIG. 1, the power transmitting unit “TX” includes a plurality of power transmitting coils “LT1” and “LT2”, a plurality of drivers “DR1” and “DR2”, a plurality of message decoders “MR1” and “MR2” and a controlling circuit “CON”, for example. The plurality of drivers “DR1” and “DR2”, the plurality of message decoders “MR1” and “MR2” and the controlling circuit “CON” form a power transmission controlling apparatus (a semiconductor integrated circuit).

The plurality of power transmitting coils include the first power transmitting coil “LT1” and the second power transmitting coil “LT2”. However, as described above, the plurality of power transmitting coils may include three or more power transmitting coils.

If the plurality of power transmitting coils “LT1” and “LT2” transmit electric power at the same time, the amount of electric power transmitted can be increased.

Note that, in this embodiment, the number of the plurality of power transmitting coils “LT1” and “LT2” is equal to the number of the plurality of power receiving coils “LR1” and “LR2”. However, the number of the power transmitting coils may be different from the number of the power receiving coils.

In addition, the plurality of power transmitting coils “LT1” and “LT2” are arranged on the same plane, and the center axes of the windings of the plurality of power transmitting coils “LT1” and “LT2” are in parallel with each other (FIG. 2).

The power transmitting coils may be displaced from each other in the direction of the center axes of the windings of the power transmitting coils, and a part of the winding of the first power transmitting coil “LT1” may overlap with a part of the winding of another power transmitting coil located adjacent thereto.

Since the plurality of power transmitting coils “LT1” and “LT2” are arranged at a distance, heat generated by each coil can be dissipated (FIG. 2).

As shown in FIG. 1, in addition, the plurality of drivers “DR1” and “DR2” are provided in a one-to-one relationship with the plurality of power transmitting coils “LT1” and “LT2”. That is, of the plurality of drivers “DR1” and “DR2”, the first driver circuit “DR1” is associated with the first power transmitting coil “LT1”, and the second driver circuit “DR2” is associated with the second power transmitting coil “LT2”.

As described above, the plurality of drivers include the first driver circuit “DR1” and the second driver “DR2”. However, the plurality of drivers may include three or more drivers in accordance with the number of the power transmitting coils.

The plurality of drivers “DR1” and “DR2” are configured to supply an alternating-current voltage to the power transmitting coils “LT1” and “LT2” to flow a primary current through the power transmitting coils “LT1” and “LT2”, thereby driving the power transmitting coils “LT1” and “LT2”.

The plurality of message decoders “MR1” and “MR2” are provided in a one-to-one relationship with the plurality of power transmitting coils “LT1” and “LT2”. That is, of the plurality of message decoders “MR1” and “MR2”, the first message decoder “MR1” is associated with the first power transmitting coil “LT1”, and the second message decoder “MR2” is associated with the second power transmitting coil “LT2”.

As described above, the plurality of message decoders include the first message decoder “MR1” and the second message decoder “MR2”. However, the plurality of message decoders may include three or more message decoders in accordance with the number of the power transmitting coils.

The plurality of message decoders “MR1” and “MR2” are configured to decode a received message or identification information “ID” and output information included in the message (information on the value of an output voltage or on a decrease or increase of the output voltage) and the identification information “ID”. Note that the identification information “ID” is information for identifying each power receiving coil that is allocated to each of the plurality of power receiving coils “LR1” and “LR2”.

For example, in a case where the first power transmitting coil “LT1” is electromagnetically coupled with the first power receiving coil “LR1”, and the second power transmitting coil “LT2” is electromagnetically coupled with the second power receiving coil “LR2”, the first and second message decoders “MR1” and “MR2” receive, via the first and second power transmitting coils “LT1” and “LT2”, messages transmitted from first and second message transmitters “MS1” and “MS2”. Then, the first and second message decoders “MR1” and “MR2” decode the messages and the identification information “ID” by envelope detection.

The controlling circuit “CON” is configured to control the plurality of drivers “DR1” and “DR2” associated with the plurality of message decoders “MR1” and “MR2” based on the information (including the identification “ID”) output from the plurality of message decoders “MR1” and “MR2”. In this way, the frequency of the alternating-current voltage supplied to the plurality of power transmitting coils “LT1” and “LT2” associated with the plurality of message decoders “MR1” and “MR2” is controlled. Besides, the power receiving unit “RX” includes a plurality of power receiving coils “LR1” and “LR2”, a plurality of rectifiers “REC1” and “REC2”, a plurality of message transmitters “MS1” and “MS2”, a battery “B” and a charger “CH”. The plurality of rectifiers “REC1” and “REC2”, the plurality of message transmitters “MS1” and “MS2” and the charger “CH” form a power reception controlling apparatus (a semiconductor integrated circuit).

The plurality of power receiving coils “LR1” and “LR2” can be electromagnetically coupled with the plurality of power transmitting coils “LT1” and “LT2”.

As described above, specific identification information “ID” is allocated to each of the plurality of power receiving coils “LR1” and “LR2”.

The plurality of power receiving coils “LR1” and “LR2” are arranged on the same plane, and the center axes of the windings of the plurality of power receiving coils “LR1” and “LR2” are in parallel with each other (FIG. 2).

The plurality of rectifiers “REC1” and “REC2” are provided in a one-to-one relationship with the plurality of power receiving coils “LR1” and “LR2”. That is, of the plurality of rectifiers “REC1” and “REC2”, the first rectifier “REC1” is associated with the first power receiving coil “LR1”, and the second rectifier “REC2” is associated with the second power receiving coil “LR2”.

As described above, the plurality of rectifiers include the first rectifier “REC1” and the second rectifier “REC2”. However, the plurality of rectifiers may include three or more rectifiers in accordance with the number of power receiving coils.

The plurality of rectifiers “REC1” and “REC2” are configured to rectify and output a secondary current flowing through the power receiving coils “LR1” and “LR2”.

The plurality of message transmitters “MS1” and “MS2” are provided in a one-to-one relationship with the plurality of power receiving coils “LR1” and “LR2”. That is, of the plurality of message transmitters “MS1” and “MS2”, the first message transmitter “MS1” is associated with the first power receiving coil “LR1”, and the second message transmitter “MS2” is associated with the second power receiving coil “LR2”.

As described above, the plurality of message transmitters include the first message transmitter “MS1” and the second message transmitter “MS2”. However, the plurality of message transmitters may include three or more message transmitters in accordance with the number of power receiving coils.

The plurality of message transmitters “MS1” and “MS2” are configured to transmit, to the plurality of message decoders “MR1” and “MR2”, messages including information based on the output voltage and the identification information “ID” output from the plurality of rectifiers “REC1” and “REC2”.

As described above, specific identification information “ID” is allocated to each of the plurality of power receiving coils “LR1” and “LR2”. The identification information “ID” and the message allocated to the first power receiving coil “LR1” are transmitted to the first power transmitting coil “LT1” electromagnetically coupled with the first power receiving coil “LR1”, for example.

In this way, the plurality of message transmitters “MS1” and “MS2” transmit the messages and the identification information “ID” to the plurality of message decoders “MR1” and “MR2” via the plurality of power receiving coils “LR1” and “LR2” and the plurality of power transmitting coils “LT1” and “LT2”.

The charger “CH” is configured to receive the output voltage output from the plurality of rectifiers “REC1” and “REC2” and charge the battery “B”.

For example, of the plurality of rectifiers “REC1” and “REC2”, the first rectifier “REC1” is configured to rectify the secondary current that flows through the first power receiving coil “LR1” because of electromagnetic coupling with the first power transmitting coil “LT1” and output the rectified secondary current to the charger “CH”.

Of the plurality of rectifiers “REC1” and “REC2”, the second rectifier “REC2” is configured to rectify the secondary current that flows through the second power receiving coil “LR2” because of electromagnetic coupling with the second power transmitting coil “LT1” and output the rectified secondary current to the charger “CH”.

The charger “CH” receives the output voltage output from the first and second rectifiers “REC1” and “REC2” and charges the battery “B”.

Next, an operation of the wireless power supply system 100 configured as described above will be described.

It will be assumed that the power transmitting unit “TX” and the power receiving unit “RX” are arranged close to each other by a user, for example.

Because of this arrangement, for example, the first power receiving coil “LR1” and the first power transmitting coil “LT1” among the plurality of power transmitting coils are electromagnetically coupled with each other. Besides, the second power receiving coil “LR2” and the second power transmitting coil “LT2” among the plurality of power transmitting coils are electromagnetically coupled with each other.

The combinations of the power transmitting coils “LT1” and “LT2” and the power receiving coils “LR1” and “LR2” electromagnetically coupled with each other vary depending on the arrangement of the power transmitting unit “TX” and the power receiving unit “RX”.

In the arrangement described above, the first message transmitter “MS1” associated with the first power receiving coil “LR1” outputs the message including the information on the output voltage and the identification information “ID” output from the first rectifier “REC1”.

Similarly, the second message transmitter “MS2” associated with the second power receiving coil “LR2” outputs the message including the information on the output voltage and the identification information “ID” output from the second rectifier “REC2”.

Then, the first message decoder “MR1” associated with the first power transmitting coil “LT1” decodes the received message and outputs the information included in the message and the identification information “ID”.

Similarly, the second message decoder “MR2” associated with the second power transmitting coil “LT2” decodes the received message and outputs the information included in the message and the identification information “ID”.

Upon recognizing the identification information “ID” allocated to the first power receiving coil “LR1”, the controlling circuit “CON” controls the first driver “DR1” associated with the first power transmitting coil “LT1” electromagnetically coupled with the first power receiving coil “LR1”.

That is, the controlling circuit “CON” controls the first driver “DR1” associated with the first message decoder “MR1” based on the information (including the identification information “ID”) output from the first message decoder “MR1”. Therefore, the frequency of the alternating-current voltage supplied to the first power transmitting coil “LT1” is controlled so that the output voltage output from the first rectifier “REC1” comes close to a target voltage.

Similarly, upon recognizing the identification information “ID” allocated to the second power receiving coil “LR2”, the controlling circuit “CON” controls the second driver “DR2” associated with the second power transmitting coil “LT2” electromagnetically coupled with the second power receiving coil “LR2”.

That is, the controlling circuit “CON” controls the second driver “DR2” associated with the second message decoder “MR2” based on the information (including the identification information “ID”) output from the second message decoder “MR2”. Therefore, the frequency of the alternating-current voltage supplied to the second power transmitting coil “LT2” is controlled so that the output voltage output from the second rectifier “REC2” comes close to a target voltage.

Then, the first rectifier “REC1” rectifies the secondary current that flows through the first power receiving coil “LR1” because of electromagnetic coupling with the first power transmitting coil “LT1” and outputs the rectified secondary current to the charger “CH”.

Similarly, the second rectifier “REC2” rectifies the secondary current that flows through the second power receiving coil “LR2” because of electromagnetic coupling with the second power transmitting coil “LT2” and outputs the rectified secondary current to the charger “CH”.

Then, the charger “CH” receives the output voltages output from the first and second rectifiers “REC1” and “REC2” and charges the battery “B”.

In this way, a predetermined voltage is supplied from the first and second rectifiers “REC1” and “REC2” to the charger “CH”.

In this way, the wireless power supply system 100 can charge the battery “B” using the plurality of power receiving coils.

Next, an example of an operation of the above-described arrangement in a case where the transmission efficiency decreases because of a foreign matter will be described.

For example, in a case where a foreign matter (a conductor), such as a coin, is placed between, and close to, the power transmitting unit “TX” and the power receiving unit “RX”, the foreign matter can absorb the transmitted electric power, and therefore, the efficiency of power transmission from the power transmitting coil to the power receiving coil can decrease.

As an example, a case where the transmission efficiency from the first power transmitting coil “LT1” to the first power receiving coil “LR1” decreases because of a foreign matter will be described.

If the transmission efficiency from the first power transmitting coil “LT1” to the first power receiving coil “LR1” decreases because of a foreign matter, the output voltage output from the first rectifier “REC1” decreases.

The first message transmitter “MS1” associated with the first power receiving coil “LR1” output the message including information on the output voltage output from the first rectifier “REC1” (information on the value of the output voltage or on a decrease of the output voltage).

Then, the first message decoder “MR1” associated with the first power transmitting coil “LT1” decodes the received message and outputs the information included in the message.

For example, if the information output from the first message decoder “MR1” shows that the output voltage output from the first rectifier “REC1” is lower than a preset threshold (that is, if the transmission efficiency is lower than a predetermined value), the controlling circuit “CON” determines that some foreign matter is absorbing the transmitted electric power and stops the first driver “DR1” driving the first power transmitting coil.

In addition, in order to increase the electric power transmitted from the second power transmitting coil “LT2” to the second power receiving coil “LR2” in compensation for having stopped driving the first power transmitting coil, the controlling circuit “CON” makes the second driver “DR2” supply an alternating-current voltage to the second power transmitting coil “LT2” to flow a primary current through the second power transmitting coil “LT2”. In this way, the second power transmitting coil “LT2” is driven.

As described above, even if driving of one power transmitting coil is stopped because of a foreign matter, the battery can be continuously charged by the remaining power transmitting coil.

In particular, the controlling circuit “CON” controls the plurality of drivers “DR1” and “DR2” so that the electric power transmitted from the plurality of power transmitting coils “LT1” and “LT2” to the plurality of power receiving coils “LR1” and “LR2” before the first driver “DR1” stops driving the first power transmitting coil “LT1” is the same as that after the first driver “DR1” stops driving the first power transmitting coil “LT1”.

As a result, even if driving of one power transmitting coil is stopped because of a foreign matter, the same level of charging as before influenced by the foreign matter can be continuously achieved using the remaining power transmitting coil.

As described above, even if one of a plurality of power transmitting coils stops transmitting electric power, the wireless power supply system according to the first embodiment can increase the electric power transmitted by the other power transmitting coils.

In this embodiment, a case where power transmitting units and power receiving units are in a one-to-one relationship has been described. However, one power transmitting unit may be associated with a plurality of power receiving units. Furthermore, the description of the embodiment of the present invention has been made on the assumption that the wireless power supply is based on the electromagnetic induction. However, the present invention is not limited to the wireless power supply based on the electromagnetic induction, and any other phenomenon (such as magnetic resonance) can be used as far as identification information or the like ensures the association between the power receiving coils and the power transmitting coils coupled to each other.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless power supply system, comprising:
a power transmitting unit that transmits electric power; and
a power receiving unit that receives the electric power output from the power transmitting unit,
wherein the power transmitting unit comprises:
a plurality of power transmitting coils;
a plurality of drivers that are provided in a one-to-one relationship with the plurality of power transmitting coils and drive the power transmitting coils by supplying an alternating-current voltage to the power transmitting coils to flow a primary current through the power transmitting coils;
a plurality of message decoders that are provided in a one-to-one relationship with the plurality of power transmitting coils, decode a received message and output information included in the message; and
a controlling circuit that controls the plurality of drivers associated with the plurality of message decoders based on the information output from the plurality of message decoders, thereby controlling a frequency of the alternating-current voltage supplied to the plurality of power transmitting coils associated with the plurality of message decoders,
the power receiving unit comprises:
a plurality of power receiving coils capable of being electromagnetically coupled with the plurality of power transmitting coils,
a plurality of rectifiers that are provided in a one-to-one relationship with the plurality of power receiving coils, rectify a secondary current flowing through the power receiving coils and output the rectified secondary current;
a plurality of message transmitters that are provided in a one-to-one relationship with the plurality of power receiving coils and transmit a message including information based on an output voltage output from the plurality of rectifiers to the plurality of message decoders; and
a charger that receives the output voltage output from the plurality of rectifiers and charges a battery,
a first message transmitter of the plurality of message transmitters associated with a first power receiving coil outputs a message including information on an output voltage output from a first rectifier,
a first message decoder of the plurality of message decoders associated with a first power transmitting coil decodes a received message and outputs information included in the message, and
if the information output from the first message decoder shows that the output voltage output from the first rectifier is lower than a preset threshold,
the controlling circuit
stops a first driver driving the first power transmitting coil
drives a second power transmitting coil of the plurality of power transmitting coils, which is different from the first power transmitting coil, by making a second driver of the plurality of drivers, which is different from the first driver, supply an alternating-current voltage to the second power transmitting coil to flow a primary current through the second power transmitting coil in such a manner that electric power transmitted from the second power transmitting coil to a second power receiving coil of the plurality of power receiving coils, which is different from the first power receiving coil, is amplified, and
controls the plurality of drivers so that the electric power transmitted from the plurality of power transmitting coils to the plurality of power receiving coils before the first driver stops driving the first power transmitting coil is equal to the electric power transmitted from the plurality of power transmitting coils to the plurality of power receiving coils after the first driver stops driving the first power transmitting coil.

2. A wireless power supply system, comprising:
a power transmitting unit that transmits electric power; and
a power receiving unit that receives the electric power output from the power transmitting unit,
wherein the power transmitting unit comprises:
a plurality of power transmitting coils;
a plurality of drivers that are provided in a one-to-one relationship with the plurality of power transmitting coils and drive the power transmitting coils by supplying an alternating-current voltage to the power transmitting coils to flow a primary current through the power transmitting coils;
a plurality of message decoders that are provided in a one-to-one relationship with the plurality of power transmitting coils, decode a received message and output information included in the message; and
a controlling circuit that controls the plurality of drivers associated with the plurality of message decoders based on the information output from the plurality of message decoders, thereby controlling a frequency of the alternating-current voltage supplied to the plurality of power transmitting coils associated with the plurality of message decoders,
the power receiving unit comprises:
a plurality of power receiving coils;
a plurality of rectifiers that are provided in a one-to-one relationship with the plurality of power receiving coils, rectify a secondary current flowing through the power receiving coils and output the rectified secondary current; and
a plurality of message transmitters that are provided in a one-to-one relationship with the plurality of power receiving coils and transmit a message including information based on an output voltage output from the plurality of rectifiers to the plurality of message decoders.

3. The wireless power supply system according to claim 1, wherein the power receiving unit further comprises a charger that receives the output voltage output from the plurality of rectifiers and charges a battery.

4. The wireless power supply system according to claim 2, wherein the power receiving unit further comprises a charger that receives the output voltage output from the plurality of rectifiers and charges a battery.

5. A power transmission controlling apparatus for a power transmitting unit having a power transmitting coil that transmits electric power to a power receiving unit having a power receiving coil, the power transmission controlling apparatus comprising:
a driver that drives the power transmitting coil by supplying an alternating-current voltage to the power transmitting coil to flow a primary current through the power transmitting coil;
a message decoder that decodes a message received from the power receiving unit and outputs information included in the message; and
a controlling circuit that controls the driver based on the information output from the message decoder to control a frequency of the alternating-current voltage supplied to the power transmitting coil, and
the controlling circuit stops the driver driving the power transmitting coil if the information output from the message decoder shows that an output voltage of the power receiving unit is lower than a preset threshold.

6. The power transmission controlling apparatus according to claim 5, wherein the power transmission controlling apparatus comprises:
a plurality of drivers that are provided in a one-to-one relationship with a plurality of power transmitting coils and drive the power transmitting coils by supplying an alternating-current voltage to the power transmitting coils to flow a primary current through the power transmitting coils;
a plurality of message decoders that are provided in a one-to-one relationship with the plurality of power transmitting coils, decode a message received from the power receiving unit and output information included in the message; and
the controlling circuit that controls the plurality of drivers associated with the plurality of message decoders based on the information output from the plurality of message decoders, thereby controlling a frequency of the alternating-current voltage supplied to the plurality of power transmitting coils associated with the plurality of message decoders, and
the controlling circuit
makes a first driver associated with a first message decoder of the plurality of message decoders stop driving a first power transmitting coil being driven depending on information output from the first message decoder, and
makes a second driver associated with a second message decoder of the plurality of message decoders stop driving a second power transmitting coil being driven depending on information output from the second message decoder.

7. The power transmission controlling apparatus according to claim 6, wherein the controlling circuit makes the first driver stop driving the first power transmitting coil if the information output from the first message decoder shows that the output voltage of the power receiving unit is lower than the preset threshold.

8. The power transmission controlling apparatus according to claim 7, wherein the controlling circuit
drives a second power transmitting coil of the plurality of power transmitting coils, which is different from the first power transmitting coil, by making a second driver of the plurality of drivers, which is different from the first driver, supply an alternating-current voltage to the second power transmitting coil to flow a primary current through the second power transmitting coil in such a manner that electric power transmitted from the second power transmitting coil to a second power receiving coil of the plurality of power receiving coils, which is different from the first power receiving coil, is amplified.

9. The power transmission controlling apparatus according to claim 8, wherein the controlling circuit
controls the plurality of drivers so that the electric power transmitted from the plurality of power transmitting coils to the plurality of power receiving coils before the first driver stops driving the first power transmitting coil is equal to the electric power transmitted from the plurality of power transmitting coils to the plurality of power receiving coils after the first driver stops driving the first power transmitting coil.

10. The power transmission controlling apparatus according to claim 6, wherein the power receiving unit further comprises a charger that receives the output voltage output from the plurality of rectifiers and charges a battery.

11. The power transmission controlling apparatus according to claim 7, wherein the power receiving unit further comprises a charger that receives the output voltage output from the plurality of rectifiers and charges a battery.

12. The power transmission controlling apparatus according to claim 8, wherein the power receiving unit further comprises a charger that receives the output voltage output from the plurality of rectifiers and charges a battery.

13. The power transmission controlling apparatus according to claim 9, wherein the power receiving unit further comprises a charger that receives the output voltage output from the plurality of rectifiers and charges a battery.

14. A power reception controlling apparatus for a power receiving unit that receives electric power output from a power transmitting unit having a plurality of power transmitting coils, the power reception controlling apparatus comprising:
a plurality of rectifiers that are provided in a one-to-one relationship with a plurality of power receiving coils capable of being electromagnetically coupled with the plurality of power transmitting coils, rectify a secondary current flowing through the power receiving coils and output the rectified secondary current; and
a plurality of message transmitters that are provided in a one-to-one relationship with the plurality of power receiving coils and independently transmit, from each power receiving coil to the power transmitting unit, a message including information based on an output voltage output from the rectifier associated with the power receiving coil.

15. The power reception controlling apparatus according to claim 14, wherein the power receiving unit further comprises a charger that receives the output voltage output from the plurality of rectifiers and charges a battery.
